(19) United States
(12) Patent Application Publication
(10) Pub. No.: US 2024/0335782 A1
(43) Pub. Date: Oct. 10, 2024

(54) CORRUGATED FILTER MEDIA

(71) Applicant: JOHNS MANVILLE, Denver, CO (US)

(72) Inventors: Joerg Meier, GroBaitingin (DE); Markus Graeber, Augsburg (DE)

(21) Appl. No.: 18/293,439

(22) PCT Filed: Aug. 23, 2022
(86) PCT No.: PCT/EP2022/073426

§ 371 Date: Jan. 30, 2024

(30) Foreign Application Priority Data
Aug. 27, 2021 (EP) 21 000 244.0

(51) Int. Cl. B01D 46/52; B01D 39/16; B01D 39/20

(52) U.S. Cl. CPC B01D 46/522; B01D 39/163; B01D 39/2024; B01D 2239/0631; B01D 2239/0654; B01D 2239/0681; B01D 2239/10; B01D 2239/1233; B01D 2239/1258; B01D 2239/1291

(57) ABSTRACT

The invention concerns a filter media having an improved efficiency, dust loading capacity and quality factor. The filter media comprises at least a corrugated self-supporting downstream layer 110 and at least an upstream layer 120. The downstream layer 110 comprises a corrugated fine fiber layer 111 consisting of fibers having a mean fiber diameter of less than 3 micrometers. The upstream layer 120 comprises a dust holding layer 122 with fibers having a mean fiber diameter of less than 5 micrometers.

### TECHNOLOGICAL FIELD

The technology disclosed herein generally relates to filter media. More particularly, the technology disclosed herein relates to filter media with improved efficiency, dust loading capacity and quality factor.

### BACKGROUND

In several filtration applications, it is required to filter a dust or particulates load out of a gaseous or liquid fluid flow. The dust particulates penetrate the filter media being captured by the media and loading the media with particulates. The life of the filter media is limited at least in part, by the increased collection of dust and other particulates by the filter media over time. As the volume and mass of the particulates on the upstream surface and inside the filter media builds up, the filter media becomes increasingly resistant to receiving airflow or a fluid flow. The resistance of airflow through the filter media is reflected by a differential pressure measurement between the upstream side and the downstream side of the filter media if the flow rate is constant, or a reduction in airflow rate if the differential pressure is constant.

An increasing differential pressure is indicative of an increasing resistance to fluid flow, and a relatively high differential pressure measurement is indicative of the end of the service life of the filter media.

To maintain a steady fluid flow rate in relation to an increasing flow resistance it is required to increase the flow pressure resulting in an increasing energy consumption of the flow producing generators (pumps, ventilators). To increase energetic efficiency of filter systems and maintaining high homogeneous filter performance over lifetime it is therefore required to provide improved filter media. Such filter media possessing a low initial pressure drop and a low increase of flow resistance and pressure drop over lifetime.

The best filter design requires consideration of not only the lowest pressure drop but also the highest particulates collection efficiency possible. The optimization of filter design is based on minimizing the pressure drop at a set flow velocity. In addition, the collection efficiency, an equally important factor, must be considered in the optimization process. The filter quality factor, which combines the collection efficiency and the pressure drop, is used as the optimization criterion for filter evaluation.

A way to increase particulate collection efficiency is to corrugate or pleat the filter media to various extents to increase the filtration area and decrease the fluid flow velocity. With increased filtration area, a lower fluid velocity in the filter media (the velocity in the layer in the direction of the flow volume) will decrease the penetration of small size particulates in the millimeter, micrometer or down to nanometer range. A decreased flow velocity will also result in a lower fluid flow resistance.

A corrugated filter is generally believed to have a relatively low filter face velocity compared to a flat filter at the same approaching velocity. The resulting improvement of filtration is due to three factors: the loading capacity, the pressure drop or resulting differential pressure and the particulate collection efficiency. Loading capacity increases in corrugated filter media because the filtration area per unit base area increases. Filter fluid flow resistance decreases with increasing pleat count, which results in higher collection efficiency. The lifetime of the corrugated or pleated filter is prolonged by an optimized design of the corrugation structure.

Depending on the field of application, the filters have to be customized in order to obtain a sufficient filtration efficiency and service life. Thus, particle-air filters for general air conditioning technology (in accordance with ISO 16890) are used as coarse, medium and fine filters in air/gas filtration, while high efficiency air filters (in accordance with EN 1822) are used in the EPA and HEPA (air) ranges or in water treatment.

U.S. Pat. No. 5,993,501 A discloses multilayer filter media and filters which consist of a stiff, pleatable base layer, the actual filter layer and a cover. These filters are particularly suitable for gas (air) and liquid filtration.

EP 1 134 013 A discloses multilayer pleated filter media and filters which consist of a stiff, pleatable base layer, the actual filter layer and a cover. These filters are constructed from polymeric melt bonded microfibers and are particularly suitable for gas (air) and liquid filtration.

EP 0 878 226 A discloses multilayer filter media and filters which are constructed from fine polymer fibers and glass fibers. These filters are particularly suitable for gas (air) and liquid filtration.

WO 2020/198681 A discloses filter media and filters which comprise a corrugated downstream filter media and planar upstream media. WO 2020/198681 A teaches to use fibers with diameters above 4 micrometers for the corrugated downstream layer and fibers with diameters above 10 micrometers for the planar or flat upstream layer.

EP 2 620 205 B discloses filter media and filters which comprise a waved fine fiber filter layer. The waved layer is embedded into a coarse fiber structure mechanically carrying and fixing the fine fiber layer. The waved layer itself is not self-supporting.

### BRIEF SUMMARY OF THE INVENTION

As discussed, there is a need for an improved filter media which satisfies high particulate collection efficiency and low energy consumption by flow generators, e.g. pumps and ventilators. The filter media must be of low volume and compact able to fit in existing generator installations, thus acting as a technically improved direct substitution media for currently used filter media in various applications, such as bag filters, or pleated filter media in automotive applications.

The present invention provides a filter media formed by at least one corrugated self-supporting filter layer comprising fine fibers in the sub to micrometer range or a multilayer filter medium, comprising such layer. Preferably such corrugated self-supporting filter layer is exhibiting a corrugation width of 3 mm to 15 mm and a corrugation depth of 0.5 mm to 20 mm and an increased dust collection surface area in the range of 1.5 to 8 times compared to a flat uncorrugated layer of the same size.

The technical objective to provide an improved filter media having an improved particulates capture efficiency, and/or having a decreased differential pressure and/or inducing a decreased power consumption over lifetime, and/or exhibiting an increased lifetime of use and/or exhibiting an improved quality factor is achieved by:

A filter media comprising at least a corrugated self-supporting downstream filter layer, such layer comprising a corrugated fine fiber layer, the corrugated fine fiber layer consisting of fibers having a mean fiber diameter of less than 3 micrometers and at least an upstream layer comprising a dust holding layer comprising fibers having a mean fiber diameter of less than 5 micrometers, and

A filter media comprising a corrugated self-supporting downstream filter layer, wherein the corrugated self-supporting downstream filter layer has a capture efficiency of at least 30% and an upstream filter layer wherein the upstream filter layer 1 has a capture efficiency of at least 20% and wherein the corrugation depth between a valley of the downstream layer and the upstream layer surface is at least 2 mm, and

A method of manufacturing a filter media, the method comprising depositing a layer of fibers having a mean fiber diameter of less than 5 micrometers onto a carrier layer, consolidating these layers by a chemical or thermal binder to an upstream filter layer, depositing a layer of fibers having a mean fiber diameter of less than 3 micrometers onto a support layer, pre-consolidating these layers by a chemical or thermal binder to a planar downstream layer, conveying and feeding the pre-consolidated downstream layer to a corrugation roller gate and corrugating the downstream layer, subsequently applying an adhesive to the peak surfaces of the corrugated downstream layer, feeding the downstream layer together with the upstream layer into a fixation gate and connecting upstream layer and downstream layer into a filter media.

### BRIEF DESCRIPTION OF THE DRAWINGS

FIG. 1 shows an example filter media according to the technology disclosed herein

FIG. 2 shows the structure of the downstream layer

FIG. 3 is showing a first example of the multiple layer filter media

FIG. 4 is showing a second example of the multiple layer filter media.

FIG. 5 shows a manufacturing assembly for the filter media

FIG. 6 shows a further example filter media according to the technology disclosed herein

FIG. 7 shows the structure of a corrugated downstream layer, comprising a fine fiber layer sandwiched in between a support and a cover layer

FIG. 8 shows examples of increasing corrugation depth for a sinusoidal corrugated upstream layer

It is noted that the figures are rendered primarily for clarity and, as a result, are not fixed to scale. Moreover, various structure/components, may be shown diagrammatically. The lack of an illustration/description of a disclosed structure or component in a figure is, however, not to be interpreted as limiting the scope of the various embodiments in any way.

### DETAILED DESCRIPTION OF THE INVENTION

The technology disclosed herein relates to a filter media that exhibits improved dust loading and overall improved filter characteristics, in particular a decreased initial pressure drop on the upstream and downstream side of the filter media. The improved dust loading can extend the useful life of the filter media. The decreased pressure drop can lower the power consumption of the fluid generators, which allows to use less powerful generators exhibiting a better energy efficiency.

Filter media consistent with the technology disclosed herein are generally used for filtering fluids like air or other gaseous media and liquid media.

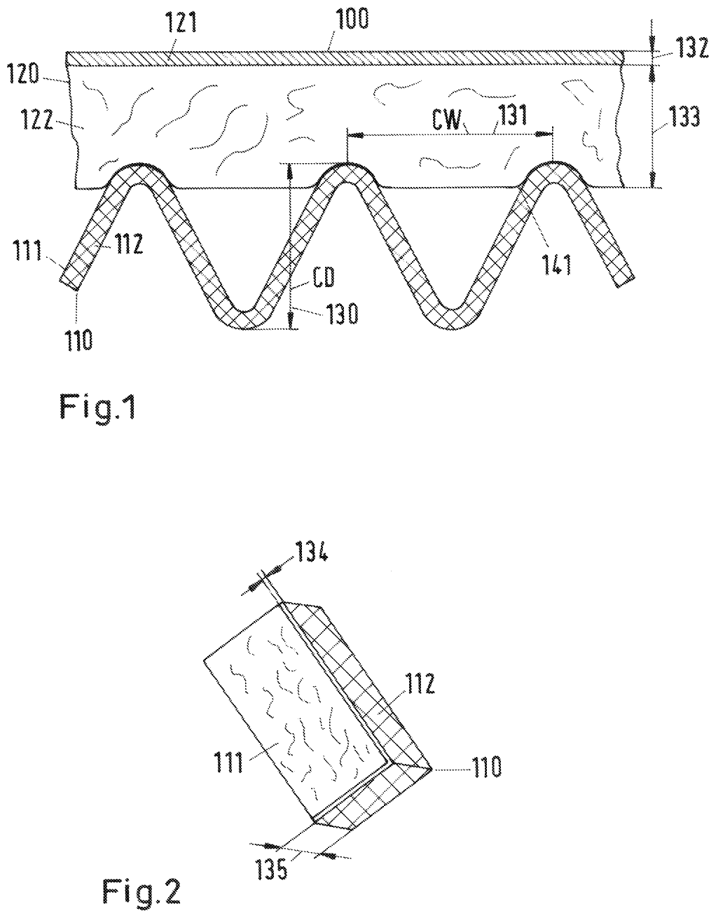

FIG. 1 shows an example filter media 100 according to the technology disclosed herein. The filter media 100 has a downstream layer of filter material 110 and an upstream layer of generally planar filter media 120. The downstream layer of filter material 110 is in a corrugated or pleated configuration. The upstream layer of filter media 120 is generally of planar and non-corrugated (non-pleated) shape. Corrugated, pleated and fluted shall have the same meaning within the scope of the invention, namely a formed or structured filter media layer having a 3-dimensional structure with increased surface area in relation to a non-structured filter layer having the same 2-dimensional size.

The example filter media 100 and corresponding components can have the same components, parameters, and properties as other embodiments of the invention described herein, except where explicitly disclosed contradictory.

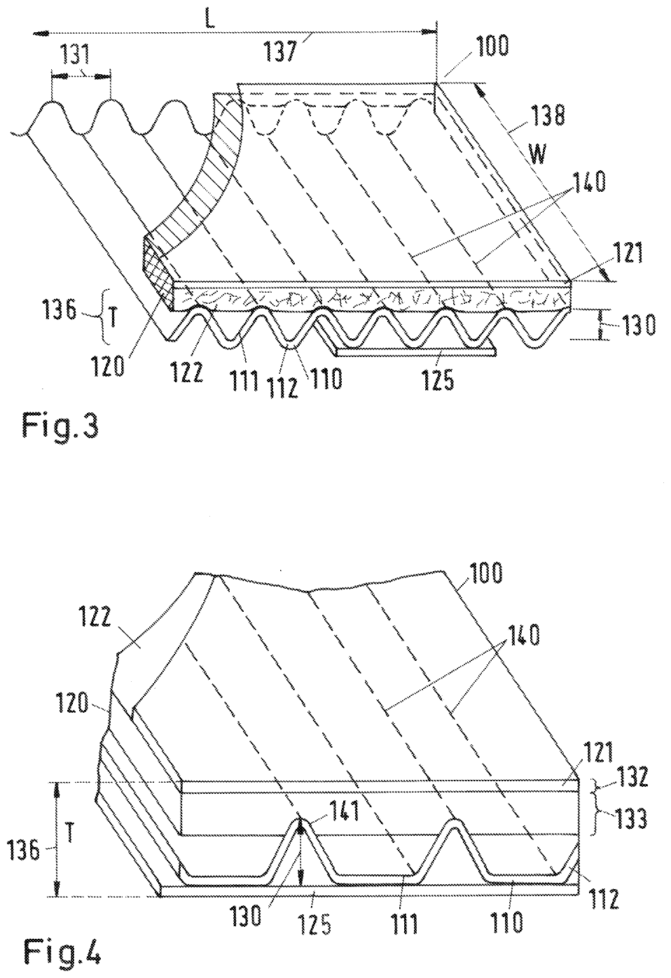

The corrugated downstream layer of filter material 110 can comprise a variety of types of filter material and combinations of types and layers of filter material. As shown in FIG. 1, FIG. 2 and FIG. 3 the corrugated downstream layer can comprise a corrugated support layer 112 carrying a corrugated fine fiber layer 111.

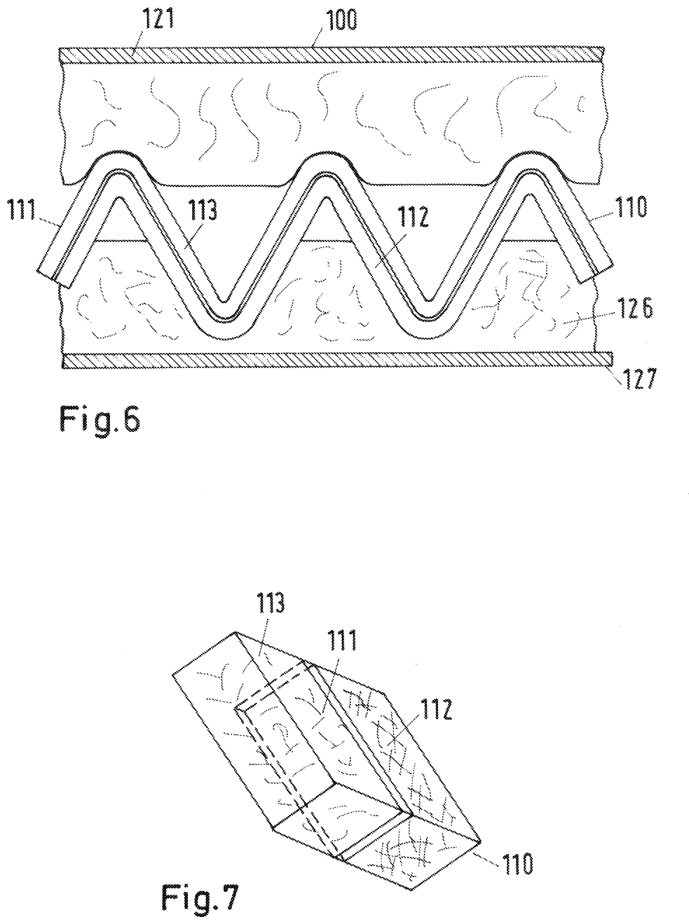

According to an alternative embodiment of the invention as shown in FIG. 6 and FIG. 7 the corrugated downstream layer can comprise a further corrugated support or cover layer 113 upstream and adjacent to corrugated fine fiber layer 111.

The corrugated downstream support layer 112 or corrugated upstream cover layer 113 of corrugated filter material 110 can contain cellulose based or other natural fibers, glass fibers, synthetic fibers or a mixture thereof.

Nonwovens, woven fabrics, non-crimp fabrics, hosiery and knitted fabrics, preferably nonwovens can be used for the corrugated support layer 112, cover layer 113 or for a textile covering or separation layer 121, 125.

The corrugated support layer 112 or corrugated cover layer 113 used in accordance with the invention is preferably a nonwoven supporting layer formed from synthetic polymer fibers, glass fibers or mixtures thereof which can be pleated.

The corrugated support layer 112 or cover layer 113, can be formed from a variety of synthetic polymer fibers. Furthermore, corrugated support layer 112 or cover layer 113, may also be multi-layered in construction. In this regard, the individual layers may differ in view of the selected synthetic polymer fiber materials and/or may have different fiber diameters. Mean fiber diameters can range from 1 micrometer to 20 micrometers, distinct sub layers of the corrugated support layer 112 or cover layer 113 may comprise fibers of mean diameters of 1, 2, 3, 5, 10, 15, 20 micrometers or values in between these. The corrugated support layer 112 or cover layer 113 can have a gradient in fiber diameter, have in particular diameter of 1 micron at the upstream surface such fiber diameter ranging to 10 to 20 micrometers at the downstream surface of corrugated support layer 112 or upstream surface of cover layer 113.

Mean fiber diameters in any layer according to the disclosed examples can be determined using a scanning electron microscope (SEM) such that 50 sample fibers, and their representative diameters, can be identified by a user and used to determine a mean fiber diameter.

The corrugated support layer 112 or cover layer 113 can be a wet laid nonwoven fabric, spun-melt fabrics, spunbonded fabric or dry laid nonwoven fabrics being consolidated by chemical binding, as well as, if appropriate, by thermal and/or mechanical consolidation. The preferred embodiments for the spun-melt fabrics or spunbonded fabrics described are also applicable to staple fiber nonwovens.

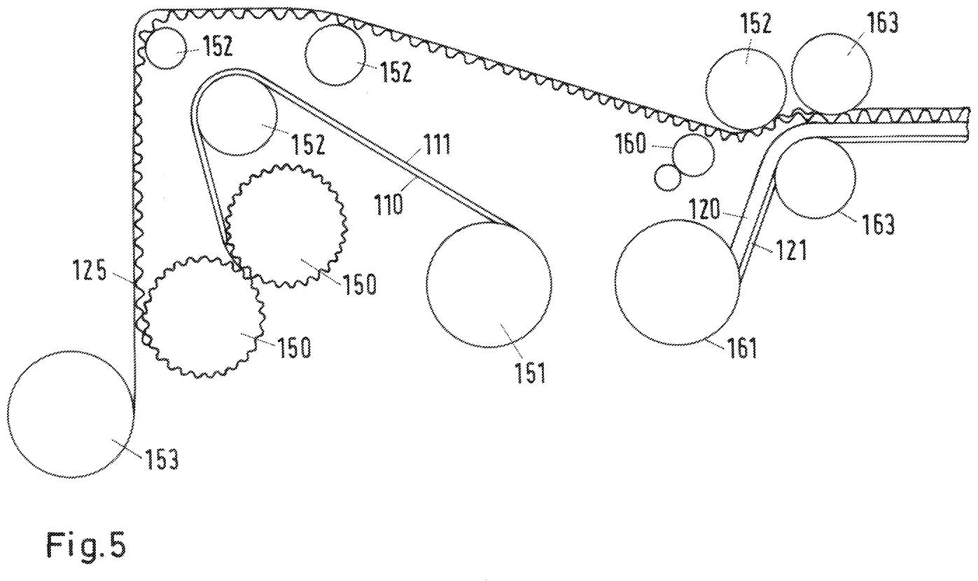

The downstream corrugated support layer 112 or cover layer 113 of filter material is preferably providing a mechanical strength or stiffening to the downstream layer 110 to be self-supporting, meaning that, upon undergoing pleating, the downstream layer of filter material 110 exhibits a stiffness allowing it to maintain a pleated configuration under the force of gravity and/or the forces exposed to during filtration operations. The corrugated support layer 112 or cover layer 113 can be connected, joined, fixed or adhered to an additional separation or support layer 125 providing additional mechanical strength or self-support performance or self-support property for the corrugated support layer 112 or cover layer 113 as shown in FIG. 3, FIG. 4 and FIG. 5.

A corrugated fine fiber layer 111 as depicted in FIG. 1 and FIG. 2, respectively FIG. 6 and FIG. 7 is located upstream and carried by the corrugated support layer 112 or sandwiched between support layer 112 and cover layer 113, these layers building the corrugated downstream layer 110.

The mean fiber diameters in corrugated fine fiber layer 111 can range from 100 nanometers to 5 micrometers, preferable showing a mean fiber diameter of 100, 200, 300, 500, 1000, 1500, 2000 up to 5000 nanometers or values in between these.

The corrugated fine fiber layer 111 can exhibit a gradient distribution of fiber diameter, in particular 100 nanometers at the upstream surface ranging to 5 micrometers at the downstream surface of corrugated fine fiber layer 111.

Various materials can be used as fiber material for corrugated fine fiber layer 111 and corrugated support layer 112 or cover layer 113, carrier layer 121, separating layer 125, backing layer 126 and support layer 127 including synthetic and non-synthetic materials. Preferably, these layers are spunbonds that are comprising or consisting of melt-spinnable polyesters. Preferred manufacturing methods are melt-spinning, wherein a molten polymer is extruded through spin nozzles and where the resulting filament is solidified by cooling. Solution spinning, wherein a spinning solution undergoes dry, wet, dry-jet wet, gel, or electrospinning techniques can also be used. Electro spinning can be used to form fibers having diameters in the order of some hundred nanometers, wherein the method uses electric force to draw charged threads of polymer solutions or polymer melts up to nanofibers. In principle, any known type of polyester material which is suitable for the production of fibers may be considered. Exemplary materials include, by way of non-limiting example, polyolefins, such as polypropylene and polyethylene; polyesters, such as poly butylene terephthalate and polyethylene terephthalate; polyamides, such as Nylon; polycarbonate; polyphenylene sulfide; polystyrene; and polyurethane. Other suitable materials are polyvinyl alcohol and polyvinylidene fluoride.

For electro spinning polyoxyethylene, polyvinyl alcohol, polyvinylpyrrolidone, polyvinyldene fluoride, polyacrylonitrile, polycaprolactone, polyactid acid, polyethersulfone, polyurethane, polystyrene, polyamide, cellulose acetate, chitosan, silk fibroin and collagen are preferred. Polyesters of this type primarily consist of components which derive from aromatic dicarboxylic acids and from aliphatic diols. Common aromatic dicarboxylic acid components are the divalent residues of benzodicarboxylic acids, in particular of terephthalic acid and of isophthalic acid; common diols contain 2 to 4 C atoms, wherein ethylene glycol is particularly suitable. Spunbonds which consist of at least 85 weight % polyethylene terephthalate are particularly preferred. The remaining 15 mol % is then made up of dicarboxylic acid units and glycol units, which act as what are known as modifiers and which enable the person skilled in the art to tailor the physical and chemical properties of the filaments which are produced. Examples of dicarboxylic acid units of this type are residues of isophthalic acid or of aliphatic dicarboxylic acids such as, for example, glutaric acid, adipic acid, sebacic acid; examples of modifying diol residues are those from long-chain diols, for example from propanediol or butanediol, from di-or tri-ethylene glycol or, as long as they are present in small quantities, of polyglycols with a molecular weight of approximately 500 to 2000.

Polyesters which contain at least 95 weight % polyethylene terephthalate (PET), in particular those from unmodified PET, are also particularly preferred.

Fine fiber layer 111 can also be formed from glass fibers.

Various manufacturing techniques can be used to form the synthetic fiber or glass fiber web, including wet-laid or dry-laid spunbond manufacturing or electrospinning. The glass fiber can be a nano or microglass fiber, such as A-type or E-type, or C-type, or T-type glass fiber made by using a rotary or flame attenuation process and having a mean fiber diameter in the range of about 100 nanometers to 5 micrometers.

Fine fiber filtration layer 111, as well as any additional filtration layer(s) 120, 121, 112, 113, 122, 125, can also have a variety of thicknesses, air permeabilities, basis weights, and filtration efficiencies depending upon the requirements of a desired application.

In a preferred example the fine fiber filtration layer 111, as measured in a planar configuration, has a thickness 134 in the range of about 500 nanometers to 3 micrometers, an air permeability in the range of about 50 1/m2/s (10 CFM) to 1500 1/m2/s (300 CFM), a basis weight in the range of about 5 grams per square meter to 50 grams per square meter and a filtration quality factor in the range of about 0.005 [1/Pa] to 10[1/Pa].

These values as other disclosed results (e.g. filter efficiency) were measured using a Palas GmbH MFP3000 modular filter media test rig. Capable measurement ranges of particle size are 0.2 micron to 40 micrometers, a volume flow of 1-35 cubic meters per h (suction mode) and an inflow velocity in the range from 5-100 cm/s. Test medium size is 100 square cm. The tests according to the disclosed invention were performed using a KCL aerosol with 0.4 micrometer mean particle size at an inflow velocity of 11 cm/s.

A quality factor qf [1/Pa] of the filter layers, layer stack was measure using the following formula:

$$qf = [ - ln ( 1 - E ) ] / Δ p \qquad Eq . ( 1 )$$

wherein E is the measured filter layer efficiency, and Δp [Pa] is the initial (unloaded) pressure drop.

The 0.4 micrometer particle size has been used in view of HEPA filters because 0.4 micrometer is regarded to fall into the range of the most penetrating particle size (MPPS) or frequently referred to as collection minimum. However, MPS is affected by filter properties and the fluid flow velocity in the filtration media.

The fine fibers in corrugated fine fiber layer 111 or DH layer 122 due to their size in the nanometer to low micrometer range are providing larger cumulative surface area for aerosol deposition. While fiber diameter is decreasing, the increase in surface area (and thus enhanced aerosol collection efficiency) is at the cost of higher friction or air resistance, leading to a higher pressure drop.

Packing density reflected by the filter layer basis weight per volume is also of importance. As packing increases, the interstitial space between adjacent fibers decreases and thus impaction and interception prevail for larger aerosol particles. Higher packing density also indicates more filtering material and larger surface area for aerosol deposition.

The filter quality should be almost independent of filter thickness because, according to Eq. (1), the changes in efficiency and pressure drop cancel out. A way to improve the filter quality factor is to charge the filter media with electric charges (electret filter) and/or providing an increased filtering surface without increasing the pressure drop or differential pressure. The fiber properties (fiber diameter distribution), filter properties (weight-thickness and packing density) and fluid velocity in the filter layer or at a given fluid flow, differential pressure behavior all influence the filter performance (or filter quality).

It is the object of the disclosed invention to provide a high-quality filter media. As to the foregoing this can be achieved by optimizing fiber dimensions and filter properties (layer weight and thickness, filter media structure). It is a particular object of the invention to provide a high-quality filter media by providing a corrugated downstream layer having an increased filter surface and exhibiting an overall decreased differential pressure drop.

This is achieved by a filter media structure according to FIG. 1 to FIG. 4 and FIG. 6 to FIG. 8.

The downstream layer of filter material 110 has a capture efficiency of at least 45% at a differential pressure of less than 25 Pa, wherein the capture efficiency is measured for a non-pleated flat sheet.

The capture efficiency of downstream filter material 110 shall be adapted to the required filter performance. According to the invention the downstream layer of filter material 110 can have a capture efficiency of at least 90%. In various embodiments the downstream layer material 110 has a capture efficiency between 10% and 80%, 20% and 40%, 60% and 99%, or 70% and 80%.

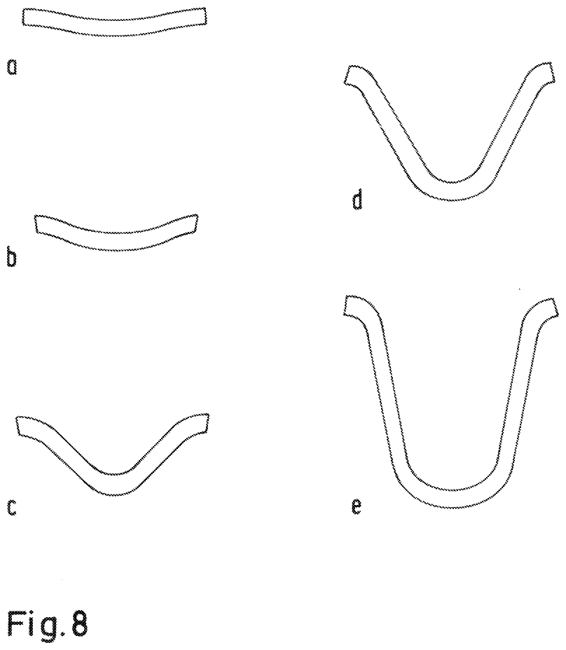

The corrugations of the downstream filter layer 110 define a plurality of peaks and valleys that alternate across the length L of the filter media 100. “Peak” and “valley” as used herein is not indicative of the specific direction of the corrugation in space, rather, the terms “peak” and “valley” are used herein is to describe corrugations that protrude in opposite directions. While the corrugations depicted in FIG. 1, FIG. 3, FIG. 6 and FIG. 8 are generally sinusoidal, the corrugations can be of triangular form as in FIG. 4 or have other shapes, e.g. being at least partly waved, at least partly sinusoidal, at least partly honeycombed or of an at least partly rectangular structure.

The corrugations can comprise discontinuities in the curvature of the waves such as one or more fold lines that extend down the length of the wave line. Furthermore, while the peaks and valleys are generally equal and opposite, in some embodiments the peaks can have a different size than the valleys.

The corrugations of the downstream filter layer 110 can have a mean corrugation depth (CD) 130 of greater than 0.5 mm. The corrugations of the downstream filter layer 110 generally have a mean corrugation depth 130 of less than 20.0 mm. In various embodiments, the downstream filter material 110 has a mean corrugation depth 130 of more than 2.0 mm. The corrugations of the downstream filter layer 110 preferably have a mean corrugation depth 130 of 3 mm to 7 mm.

Corrugation depth (CD) is defined as the z-direction distance between a peak and an adjacent valley of the downstream filter layer 110, where the z-direction is perpendicular to the length (L) 137 and the width (W) 138 of the filter layer 110.

Corrugation depth (CD) is represented by the mean corrugation depth determined by an average of a sample of corrugations depths measured across the filter layer 110.

The upstream layer of fibers 120 generally extends across the peaks of the downstream filter layer 110, wherein upstream layer 120, in particular dust holding layer 122 can partly extend into the valleys of downstream filter layer 110.

The upstream fiber layer or fiber layer stack 120 can be adhered to or coupled to the downstream filter layer 110.

The upstream filter layer 120 or vice versa downstream filter layer 110 can be coupled at the peak contact areas 140 with an adhesive or the material forming at least a portion of the fibers within the upstream filter layer 120 self-adhere to the downstream filter layer 110. The upstream filter layer 120 can self-adhere when, for example, uncured (or wet) fibers are deposited across the downstream filter layer 110 (not shown in FIG. 5) and left to cure (or dry). The upstream filtration layer 120 can consist of loose fibers, meaning that the fibers in the upstream filter layer 120 are substantially unbonded to each other.

The upstream filter layer 120 can also comprise a scrim material. The scrim material can be woven, non-woven or knit fibers, for example.

The upstream filter layer 120 generally extends across a substantial portion of the downstream filter media layer 110.

While the downstream layer 110 is generally corrugated, the upstream layer 120 is generally non-corrugated and planar. However, the upstream layer 120 might be not perfectly planar, because portions of the upstream layer 120 positioned between adjacent peaks of the downstream layer 110 can sag in response to gravity, compacting or fixation, forming a depression 141 along the contact lines or contact areas 140.

The corrugations of downstream layer 110 are creating a void space for dust capture between the downstream layer 110 and the upstream layer 120. Such void space between the layers 110, 120 can be determined by the corrugation depth (CD) and the corrugation width (CW) 131.

In a configuration as to FIG. 6 fine fiber layer 111 can be positioned in between a support layer 112 and a cover layer 113. A further backing layer 126 can be positioned downstream of the corrugated downstream filter layer 110. The backing layer having 126 can be covered by a further downstream face or support layer 127. Backing layer 126 preferably comprising polymer fibers having a diameter in the range of 3 micrometers to 15 micrometers. Support layer 127 preferably comprising polymer fibers having a diameter in the range of 10 micrometers to 25 micrometers. Additional backing layer 126 and additional support layer 127 being configured to withstand perpendicular compression forces of 50 to 1000 N per square meter during packaging and shipping of the filter media 100.

The corrugation width 131 is defined as the distance between two peaks of the downstream layer 110 in length direction L as shown in FIG. 3 and is generally constant. The corrugation width is preferably greater than 0.2 mm. The corrugation width 131 is generally less than 30.0 mm. The mean corrugation width 131 is preferably between 3 and 15 mm, most preferably between 5 to 10 mm.

In view of an optimized quality factor of the filter media, in particular an optimized performance of the corrugated downstream layer 110 both corrugation depth 130 and corrugation width 131 have to be set in an optimized relation to effectively increase the filter surface area of upstream filter 110 and decrease the differential pressure in the corrugated layer material.

The ratio ration between corrugation width 131 to corrugation depth 130 shall be in the range of 0.5 to 4, preferably a ratio of 1 to 3, resulting in a surface area increase of a corrugated sinusoidal wave structure of 800% to 150%, respectively 418% to 172%.

FIG. 8 depicts various sinusoidal corrugation levels, wherein the corrugation ratio as to FIG. 8ais 6.25, as to FIG. 8b the ratio is 4.2, as to FIG. 8c the ratio is 2.5, as to FIG. 8d the ratio is 1.38 and as to FIG. 8e the ratio is 0.93.

As to FIG. 1 the upstream layer of filter media 120 is generally planar and non-corrugated (non-pleated). Upstream layer 120 preferably comprises a carrier layer 121 and a dust holding layer (DH) 122. The dust holding layer DH having a thickness 133 in the range of 2 mm to 20 mm, preferably 3 mm to 8 mm and the carrier layer 121 having a thickness 132 in the range of 0.1 mm to 3 mm, preferably 0.8 mm to 1.5 mm, also depending on the filtration performance and application requirements.

In a configuration as to FIG. 6 filter media 100 comprises an additional support layer 127 and an additional support and/or dust holding layer 126 located downstream to the corrugated filter layer 110 and being connected to layer 110. Additional support layer and/or dust holding layer 126 at least partly filling the upstream voids of the corrugated downstream layer 110 by more than 20%, preferably more than 50% and most preferably with a filling grade of more than 80%. Layer 126 preferably being interconnected, bonded or adhered or mechanically fixed to downstream layer 110.

The basis weight of the carrier layer 121, preferably of the nonwoven carrier layer 121, is between 5 and 50 g/m2, preferably 10 and 30 g/m2, in particular in the range of 15 to 25 g/m2. The carrier layer 121 can comprise polymer fibers and/or glass fibers. A glass fiber containing carrier layer 121 having a basis weight between 10 and 30 g/m2, preferably between 18 and 25 g/m2. The carrier layer 121 can also comprise polymer fibers, preferably PET fibers in a percentage range of up to 50% by weight, preferably between 1 to 30% by weight, in particular 5 to 15% by weight.

The diameter of the glass fibers in the carrier layer 121, preferably bio degradable E-glass fibers, can be in the range of between 5-20 micrometers, preferably 10 to 15 micrometers. The fiber length can be in the range of 5 to 50 mm, preferably in the range of 10 to 25 micrometers.

The polymer fibers in carrier layer 121 may be used as binder fibers for thermal consolidation. The fibers may also have a two-component structure (for example core/sheath), in which the sheath is the binder polymer.

Alternatively, or in addition to binder fibers which are capable of thermal consolidation, the carrier layer can be impregnated with a chemical binder. Various binder systems, in particular, binders based on acrylates or styrenes may be considered. The binder fraction is advantageously up to 25% by weight, preferably up to 5 t 20% by weight. A feasible binder might comprise urea resin, polyacrylate, polyvinyl acetate based binder or a composition of such binder components.

The supporting carrier layer 121 and or backing layer 126 and or support layer 127 in accordance with the invention has an air permeability of at least 5000 L/m2 sec. Preferably, the carrier layer 121 has an air permeability in the range of 7500 to 20000 L/m2 sec, measured respectively in accordance with DIN EN ISO 9237.

The dust holding layer DH 122 supported by the carrier layer 121 can comprise glass fibers. Instead of glass fibers, mineral fibers based on aluminosilicates, ceramics, dolomite fibers or fibers from vulcanites such as, for example, basalt diabases, melaphyre diabases (dolerite) and melaphyres (what are known as paleobasalts) may be used.

Any glass type such as E glass, S glass, R glass, C glass may be used. E glass or C glass is preferred. Bio-degradable glasses are particularly preferred.

The glass fiber based nonwoven forming the dust holding filter layer 122 can be produced using known dry laid processes.

The glass fiber nonwoven dust holding layer DH 122 can comprise a range of glass fiber diameters. The glass fiber diameters might range between 500 nm to 5 micrometers, having a mean diameter of 1 to 5 micrometers, preferable 2 micrometers to 3.5 micrometers.

The glass fiber nonwoven dust holding layer DH 122 can also comprise a mixture of at least two glass fiber types, wherein the first glass fiber type of the mixture has a diameter which is determined as the mean of a normal Gaussian distribution of 0.6 μm±0.3 μm, preferably ±0.2 μm, and the second glass fiber type of the mixture has a diameter which is determined as the mean of a normal Gaussian distribution of 1.0 μm±0.3 μm, preferably ±0.2 μm, and the first and second glass fiber types of the mixture are in a ratio by weight in the range 1:1.1 to 1:4, preferably 1:1.5 to 1:3, particularly preferably 1:2.

The glass fiber nonwoven dust holding layer DH 122 can comprise chemical binders for consolidation and can be manufactured according to the air media method.

The glass fiber nonwoven dust holding layer DH 122 preferably comprises fibers with a mean length of between 0.3 and 100 mm.

The glass fiber nonwoven dust holding layer DH 122 preferably contains between 5 and 30% by weight of chemical binders, with respect to the total weight of the filter layer after drying.

The glass fiber nonwoven dust holding layer DH 122 has a basis weight of between 25 and 150 g/m2, preferably between 50 and 70 g/m2.

The glass fiber nonwoven dust holding layer DH 122 has a thickness of between 1 and 20 mm, in particular between 4 and 7 mm.

The glass fiber nonwoven dust holding layer DH 122 has an air permeability of at least 2500 L/m2 sec, preferably an air permeability of more than 8500 L/m2 sec, measured in accordance with DIN EN ISO 9237.

The glass fiber nonwoven dust holding layer DH 122 shows a differential pressure of less than 12 Pa and an efficiency of more than 15% at a weight of more than 50 g/m2 and at a thickness of more than 4 mm using a KCL aerosol with 0.4 micrometer mean particle size at an inflow velocity of 11 cm/s.

The dust holding layer DH 122 supported by the carrier layer 121 and/or backing layer 126 and/or support layer 127 can comprise or can consist of polymer fibers.

The polymer fiber based nonwoven or spunbond forming the dust holding filter layer 122 carrier layer 121 and/or backing layer 126 and/or support layer 127 can be produced by melt spinning and using known dry laid processes.

The glass fiber nonwoven dust holding layer DH 122 carrier layer 121 and/or backing layer 126 and/or support layer 127 can comprise a range of polymer fiber diameters. The polymer fiber diameters might range between 3 to 30 micrometers, having a mean diameter of 5 to 15 micrometers, preferable 7 micrometers to 10 micrometers.

The upstream layer 120 in accordance with the invention has an air permeability of at least 2000 l/m2 sec at an air velocity of 0.04 to 0.2 m/s and a differential pressure below 25 Pa, preferably below 12 Pa. Preferably, the upstream layer 120 has an air permeability in the range 5000 to 15000 l/m2 sec, measured respectively in accordance with DIN EN ISO 9237.

The filter media 100 shall have an overall thickness (T) 136 of 3 mm to 30 mm preferably between 5 and 15 mm.

As to FIG. 5 the filter media can be produced by forming the upstream layer 120 or supplying the ready-formed upstream layer from a carrier roll 161. The upstream layer 120 is preferably provided in the form of rolled goods. The upstream layer is manufactured by depositing a layer of fibers 122 having a mean fiber diameter of less than 5 micrometers onto a carrier layer 121 and consolidating these layers 121, 122 by a chemical or thermal binder or ultrasonic activation to an upstream layer 120. Alternatively, the upstream layer can be manufactured by calendaring of the fibers of layers 122, 121 and can be consolidated by ultrasonic welding or ultrasonic melting.

The corrugated downstream layer 110 will be manufactured from a planar filtration stack 110, 111, 112 as shown in FIG. 2 and carrying a fine fiber layer 111 as disclosed in accordance to the invention. The pre-corrugated planar upstream layer stack 11, 112 can be manufactured by depositing a layer of fibers 111 having a mean fiber diameter of less than 3 micrometers onto a support layer 112, and pre-consolidating these layers 111, 112 by a chemical or thermal binder to a planar downstream layer 110. The planar pre-corrugated layer 110 is preferably also provided in the form of rolled goods.

Subsequently, the planar pre-corrugated layer 110 is fed to a pleating or corrugation device, preferably a corrugation roller gate comprising rollers, such rollers 150, 150 comprising a structured or grooved surface. The rollers 150 or compactors can have any kind of matching surface structure for pleating. The surface can be at least partly waved, at least partly sinusoidal, at least partly honeycombed or of an at least partly rectangular structure. Adjacent surface areas of the mechanism or rollers 150 shall engage into each other upon conveying of the planar layer 110 thereby impressing or pleating the desired corrugation.

The rollers 150 can be heatable to 50 to 200 degrees Celsius, preferably to 100 to 150 degrees Celsius for thermal corrugation of meltable binder fibers or thermally induced binder consolidation.

An additional separating, supporting or backing layer 125 may be fed by a separating layer feed roll 153, the separating layer 125 being connected to the corrugated downstream filter layer 110 by an applicator or connection device (not shown). The connection or fixation of layers 125, 110 can be performed by adhesion or needling or calendaring or ultrasonic welding or other feasible technologies. The filter stack of separating layer 125 and corrugated downstream layer 110 is conveyed via guide rollers 152 to an application roll 160 for an adhesive, the adhesive being applied by the application roll 160 to the peak surfaces of corrugated downstream filter layer 110.

Subsequently, the adhesive carrying downstream filter stack 110, 125 together with the upstream filter stack 120 is fed to a fixation gate, comprising fixation and compactor rolls 163. The rollers 163 or compactors are preferably flexible or swimming rolls to induce a low-level fixation pressure.

In an alternative configuration of the filter media 100 according to FIG. 6 and FIG. 7 an additional separating, supporting or backing layer 126 may be connected to the corrugated downstream filter layer 110 (not shown in FIG. 5). The connection or fixation of layers 126, 110 can be performed by adhesion calendaring or ultrasonic welding or other feasible technologies. Layer 126 can also be manufactured by depositing a layer of fibers into the downstream corrugations of corrugated filter layer 110, at least partially filling the voids and preferably building a substantially planar downstream surface. Such substantially planar downstream surface of layer 126 covered or supported by an additional support layer or separation layer 127.

The filter stack of separating layer 125 and corrugated downstream layer 110 and support layers 126, 127 conveyed and connected to upstream layer 120 as described in the forgoing.

Table 1 shows test results measure for an example filter media comprising a flat non-corrugated downstream layer 110 and a corrugated downstream layer 110 according to FIG. 1 The downstream filter layer 110 has an overall thickness of 1.2 mm, wherein the support layer 111 has a thickness 135 of 1 mm and the fine fiber layer 112 has a thickness of around 0.2 mm. Both support layer 111 and fine fiber layer consist of synthetic polymer fibers.

The fiber diameter in support layer 112 or cover layer 113 is in the range of 1 micrometers to 10 micrometers, with a mean fiber diameter of around 5 micrometers. The mean fiber diameter in the fine fiber layer 112 is around 600 nanometers and ranges from around 200 nanometers to around 1500 nanometers.

Corrugated downstream layer 110 has the same physical values except for being corrugated.

The corrugation depth of the sinusoidal wave structure was set to 3.7 mm, the corrugation width to 6 mm, which leads to a corrugation ratio of 1.62 and a calculated surface area increase of 260% for the corrugated downstream layer 110 compared to a flat downstream layer 110. Flat downstream layer 110 has a basic weight of 70 gram per square meter (corrugated) and 30 gram per square meter (flat).

Upstream filter layer 120 has an overall thickness of 4 mm, wherein the carrier or backing layer 121 has a thickness of 1 mm and the dust holding layer 122 has a thickness of around 3 mm. Backing or carrier layer 121 layer consist of a mixture of synthetic polymer fibers (around 10% PET fibers of 2 micrometer mean diameter) and E-glass fibers (around 90% fibers having a mean diameter of around 15 micrometers). Dust holding upstream layer 122 consists of glass fibers having a mean fiber diameter of 2.5 micrometer.

Filter media performance was measured using a Palas GmbH MFP3000 modular filter media test rig. The tests according to Table 1 were performed using a KCL aerosol with 0.4 micrometer mean particle size at an inflow velocity of 11 cm/s.

As to the test results detailed in Table 1 the filter media comprising a non-corrugated fine fiber layer (synthetic efficiency layer-flat) shows a filter efficiency of 79% compared to a filter efficiency of 85% in the media comprising a corrugated fine fiber upstream layer (synthetic fiber efficiency layer-corrugated. The measured initial pressure drop was 55 Pa (flat) respectively 41 Pa (corrugated). The calculated quality factor qf (calculated using Eq. 1) increased from 0.0284 to 0.0463, which is an increase of 163%.

TABLE 1

| | | Pressure | Quality |
|---|---|---|---|
| | Efficiency | dropᵢₙᵢₜᵢₐₗ | factor |
| Media design | [%] | [Pa] | [1/Pa] |
| Layer 1: | 79 | 55 | 0.0284 |
| Glass fiber dust holding layer | | | |
| Layer 2: | | | |
| Synthetic fiber efficiency layer - flat | | | |
| Layer 1: | 85 | 41 | 0.0463 |
| Glass fiber dust holding layer | | | |
| Layer 2: | | | |
| Synthetic fiber efficiency layer - | | | |
| corrugated | | | |

1. Filter media 100 comprising:
at least a corrugated self-supporting downstream layer 110 comprising a corrugated fine fiber layer 111, the corrugated fine fiber layer 112 consisting of fibers having a mean fiber diameter of less than 3 micrometers and at least an upstream layer 120 comprising a dust holding layer 122 comprising fibers having a mean fiber diameter of less than 5 micrometers.

2. Filter media 100 according to claim 1, wherein the fibers of downstream layer 110 consists of a electro-spinnable or rotary melt spinnable polymer such as polyoxyethylene, polyvinyl alcohol, polyvinylpyrrolidone, polyvinyldene fluoride, polyacrylonitrile, polycaprolactone, polyactid acid, polyethersulfone, polyurethane, polystyrene, polyamide, cellulose acetate, chitosan, silk fibroin or collagen.

3. Filter media 100 according to claim 1 or claim 2, wherein the dust holding layer 122 comprises at least 80% of glass fibers, preferably E glass or C glass fibers, most preferably bio-soluble glasses fibers.

4. Filter media 100 according to claim 1 or claim 2, wherein the dust holding layer 122 comprises polymer fibers such as polyolefins, polypropylene, polyethylene, polyesters, poly butylene terephthalate, polyethylene terephthalate, polyamides, such as Nylon; polycarbonate; polyphenylene sulfide; polystyrene, polyvinyl alcohol or polyvinylidene fluoride.

5. Filter media 100 according to claim 1, wherein the upstream layer 120 has a basic weight of 50 gram per square meter to 100 grams per square meter.

6. Filter media 100 according to any of the preceding claims claim 1 to 5, wherein the corrugated downstream layer 110 has a basic weight of 50 grams per square meter to 200 grams per square meter.

7. Filter media 100 according to any of the preceding claims claim 1 to 6, wherein the mean corrugation width of downstream layer 110 is preferably between 3 and 15 mm, most preferably between 5 to 10 mm.

8. Filter media 100 according to any of the preceding claims claim 1 to 7, wherein the mean corrugation depth of downstream layer 110 is between 0.5 mm and 20 mm, preferably between 3 mm to 15 mm, most preferably between 5 to 10 mm.

9. Filter media 100 according to any of the preceding claims claim 1 to 8, wherein the self-supporting downstream filter layer 110 and or the upstream filter layer 120 are consolidated by chemical binders and/or by thermoplastic binders, calendaring or ultrasonic activation.

10. Filter media 100 according to any of the preceding claims claim 1 to 9, wherein the corrugated downstream layer 110 exhibits a surface area increase in the range of 150% to 800% compared to a non-corrugated media.

11. Filter media 100 according to any of the preceding claims claim 1 to 10, having an intitial pressure drop of less than 50 Pa and a filter efficiency of more than 50%, measured using a KCl aerosol with 0.4 micrometer mean particle size at an inflow velocity of 11 cm/s.

12. Filter media 100 according to any of the preceding claims wherein an additional substantially planar backing or supporting layer 126 is connected downstream to the corrugated downstream layer 110.

13. Filter media 100 comprising:
a corrugated self-supporting downstream layer 110, wherein the corrugated self-supporting downstream layer 110 has a capture efficiency of at least 30% and an upstream layer 120 wherein the upstream layer 120 has a capture efficiency of at least 20% and the corrugation depth 130 between a valley of the downstream layer and the upstream layer surface is at least 2 mm.

14. A method of manufacturing a filter media 100, the method comprising:
depositing a layer of fibers 122 having a mean fiber diameter of less than 5 micrometers onto a carrier layer 121,
consolidating these layers 121, 122 by a chemical or thermal binder to an upstream layer 120,
depositing a layer of fibers 111 having a mean fiber diameter of less than 3 micrometers onto a support layer 112 or cover layer 113,
pre-consolidating these layers 111, 112 by a chemical or thermal binder to a planar downstream layer 110,
conveying and feeding the pre-consolidated downstream layer 110 to a corrugation roller gate 150 and corrugating the downstream layer 110,
subsequently applying an adhesive to the peak surfaces of the corrugated downstream layer 110,
feeding the downstream layer 110 together with the upstream layer 120 into a fixation gate 163 and connecting downstream layer 110 and upstream layer 120 into a filter media 100.

15. The method of claim 14, wherein an additional carrier or separating layer 125 is connected to layer 110 after the corrugation step.

16. The method of claim 14 or claim 15, wherein an additional support or backing layer 126 is connected to layer 110 after the corrugation step, the support or backing layer fibers at least partly filling the corrugations of corrugated downstream layer 110.

17. The method of claim 16, wherein an additional support or separating layer 127 is connected to a substantially planar downstream surface of support or backing layer 126.

18. The method of claim 14 or claim 15<, wherein the pre-corrugated layer 110 is heated to 100 to 150 degrees Celsius during corrugation.
